(19) United States
(12) Patent Application Publication
(10) Pub. No.: US 2025/0272214 A1
(43) Pub. Date: Aug. 28, 2025

(54) SYSTEM AND METHOD FOR GENERATING SOFTWARE CODE CRITICALITY AND EXECUTION HEATMAPS TO OPTIMIZE RESOURCE CONSUMPTION

(71) Applicant: BANK OF AMERICA CORPORATION, Charlotte, NC (US)

(72) Inventors: Venugopala Rao Randhi, Hyderabad (IN); Rama Venkata S. Kavali, Frisco, TX (US); Damodarrao Thakkalapelli, Plano, TX (US); Vijaya Kumar Vegulla, Hyderabad (IN)

(73) Assignee: BANK OF AMERICA CORPORATION, Charlotte, NC (US)

(21) Appl. No.: 18/585,525

(22) Filed: Feb. 23, 2024

(51) Int. Cl. G06F 11/36

(52) U.S. Cl. CPC G06F 11/3604; G06F 11/3676

(57) ABSTRACT

Embodiments of the present invention provide a system for generating software code criticality and execution heatmaps to optimize resource consumption. The system is configured for accessing one or more entity applications associated an entity, wherein the one or more entity applications comprises lines of program code, parsing through the lines of program code associated with the one or more entity applications, generating tokens for each of the lines of program code, generating heatmap associated with each of the lines of program code, wherein the heatmap comprises visual representations associated with each of the tokens generated for each of the line of program code, and displaying the heatmap to one or more users.

### BACKGROUND

There exists a need for a system for generating software code criticality and execution heatmaps to optimize resource consumption.

### BRIEF SUMMARY

Embodiments of the present invention address the above needs and/or achieve other advantages by providing apparatuses (e.g., a system, computer program product and/or other devices) and methods for generating software code criticality and execution heatmaps to optimize resource consumption. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention accesses one or more entity applications associated an entity, wherein the one or more entity applications comprises lines of program code, parses through the lines of program code associated with the one or more entity applications, generates tokens for each of the lines of program code, generates heatmap associated with each of the lines of program code, wherein the heatmap comprises visual representations associated with each of the tokens generated for each of the line of program code, and displays the heatmap to one or more users.

In some embodiments, the present invention generates the heatmap associated with each of the lines of program code based on executing the lines of program code based on test data.

In some embodiments, the present invention determines one or more gaps in the test data based on the heatmap and performs one or more corrective actions based on determining the one or more gaps.

In some embodiments, the one or more corrective actions comprise at least one of generating and transmitting alerts to one or more users associated with the one or more entity applications, modifying at least one of the lines of program code, commenting out the at least one of the lines of program code, and rearranging the lines of program code.

In some embodiments, the one or more corrective actions improve the resource consumption of one or more entity systems executing the lines of program code associated with one or more entity applications.

In some embodiments, the present invention the visual representations comprise representations that denote criticality and execution frequency associated with each of the lines of program code.

In some embodiments, the present invention the one or more entity applications comprise modules, wherein each of the modules comprise submodules, and each of the submodules comprise the lines of program code.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for generating software code criticality and execution heatmaps to optimize resource consumption, in accordance with an embodiment of the invention;

FIG. 2 provides a block diagram illustrating the entity system 200 of FIG. 1, in accordance with an embodiment of the invention;

FIG. 3 provides a block diagram illustrating an resource consumption optimization system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for generating software code criticality and execution heatmaps to optimize resource consumption, in accordance with an embodiment of the invention;

FIGS. 6A and 6B illustrate examples for generating software code criticality and execution heatmaps with test data, in accordance with an embodiment of the invention; and

FIG. 7 illustrates a heatmap generated by the resource consumption optimization system 300, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that creates, manages, develops, provides, maintains, and/or uses one or more applications (e.g., web applications, mobile applications, or the like) to perform one or more activities. In some embodiments, the entity may be a financial institution which may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, an entity may develop, use, maintain, and/or the one or more entity applications. Such entity applications developed by one or more users may have different execution times, which may cause performance issues in entity servers hosting the entity applications. As such, there exists a need for a system to optimize the entity applications such that execution of the entity applications does not deteriorate the performance of the entity servers. The system of the invention provides a solution to this problem as explained below.

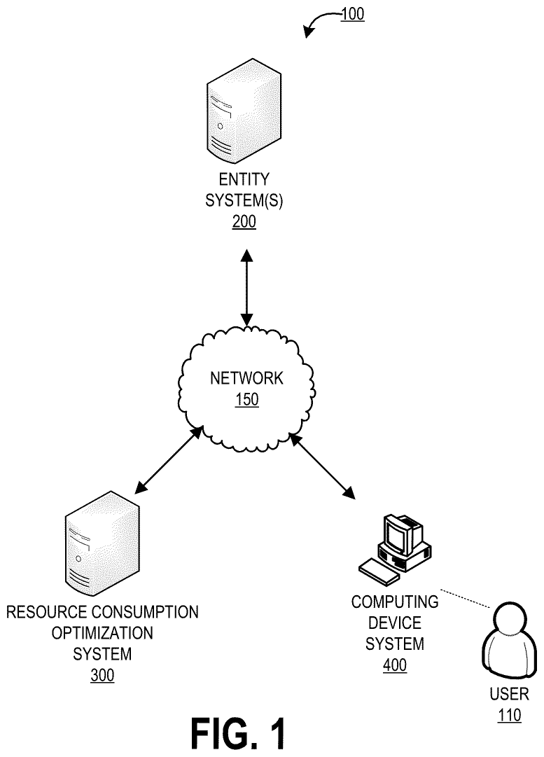

FIG. 1 provides a block diagram illustrating a system environment 100 for generating software code criticality and execution heatmaps to optimize resource consumption, in accordance with an embodiment of the invention. As illustrated in FIG. 1, the environment 100 includes a resource consumption optimization system 300, entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200 (e.g., software engineer, application developer, application tester, and/or the like). In some embodiments, the one or more user(s) 110 of the system environment 100 may further comprise end-users which may include, but are not limited to, customers, potential customers, or the like of the entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution.

The resource consumption optimization system 300 is a system of the present invention for performing one or more process steps described herein. In some embodiments, the resource consumption optimization system 300 may be an independent system. In some embodiments, the resource consumption optimization system 300 may be a part of the entity system 200.

The resource consumption optimization system 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource consumption optimization system 300 is configured to communicate information or instructions with the entity system 200, and/or the computing device system 400 across the network 150.

The computing device system 400 may be a computing device of the user 110. In general, the computing device system 400 communicates with the user 110 via a user interface of the computing device system 400, and in turn is configured to communicate information or instructions with the resource consumption optimization system 300 and/or entity system 200 across the network 150.

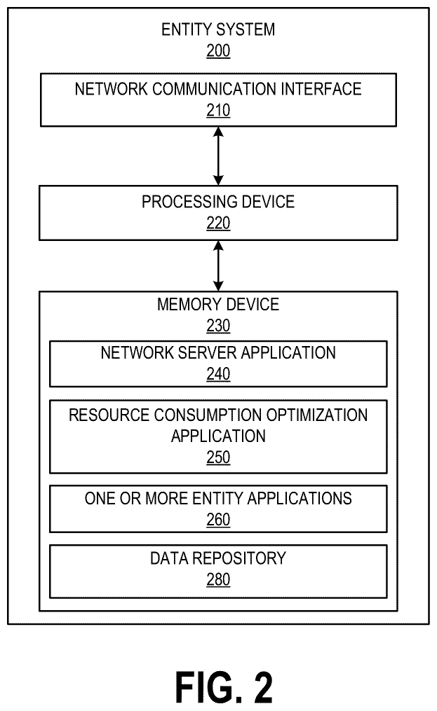

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a resource consumption optimization application 250, one or more entity applications 260, and a data repository 280. The computer-executable program code of the network server application 240, the resource consumption optimization application 250, and the one or more entity applications 260 to perform certain logic, data-extraction, and data-storing functions of the entity system 200 described herein, as well as communication functions of the entity system 200.

The network server application 240, the resource consumption optimization application 250, and the one or more entity applications 260 are configured to store data in the data repository 280 or to use the data stored in the data repository 280 when communicating through the network communication interface 210 with the resource consumption optimization system 300, and the computing device system 400 to perform one or more process steps described herein. In some embodiments, the entity system 200 may receive instructions from the resource consumption optimization system 300 via the resource consumption optimization application 250 to perform certain operations. The resource consumption optimization application 250 may be provided by the resource consumption optimization system 300.

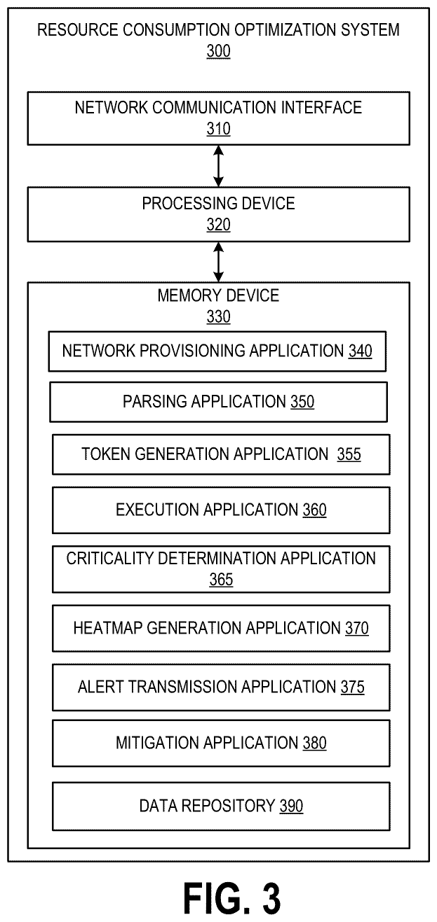

FIG. 3 provides a block diagram illustrating the resource consumption optimization system 300 in greater detail, in accordance with embodiments of the invention. As illustrated in FIG. 3, in one embodiment of the invention, the resource consumption optimization system 300 includes one or more processing devices 320 operatively coupled to a network communication interface 310 and a memory device 330. In certain embodiments, the resource consumption optimization system 300 is operated by an entity, such as a financial institution, while in other embodiments, the resource consumption optimization system 300 is operated by an entity other than a financial institution. In some embodiments, the resource consumption optimization system 300 is owned or operated by the entity of the entity system 200. In some embodiments, the resource consumption optimization system 300 may be an independent system. In alternate embodiments, the resource consumption optimization system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the resource consumption optimization system 300 described herein. For example, in one embodiment of the resource consumption optimization system 300, the memory device 330 includes, but is not limited to, a network provisioning application 340, a parsing application 350, a token generation application 355, an execution application 360, a criticality determination application 365, a heatmap generation application 370, an alert transmission application 375, a mitigation application 380, and a data repository 390 comprising data processed or accessed by one or more applications in the memory device 330. The computer-executable program code of the network provisioning application 340, the parsing application 350, the token generation application 355, the execution application 360, the criticality determination application 365, the heatmap generation application 370, the alert transmission application 375, and the mitigation application 380 may instruct the processing device 320 to perform certain logic, data-processing, and data-storing functions of the resource consumption optimization system 300 described herein, as well as communication functions of the resource consumption optimization system 300.

The network provisioning application 340, the parsing application 350, the token generation application 355, the execution application 360, the criticality determination application 365, the heatmap generation application 370, the alert transmission application 375, and the mitigation application 380 are configured to invoke or use the data in the data repository 390 when communicating through the network communication interface 310 with the entity system 200, and the computing device system 400. In some embodiments, the network provisioning application 340, the parsing application 350, the token generation application 355, the execution application 360, the criticality determination application 365, the heatmap generation application 370, the alert transmission application 375, and the mitigation application 380 may store the data extracted or received from the entity system 200 and the computing device system 400 in the data repository 390. In some embodiments, the network provisioning application 340, the parsing application 350, the token generation application 355, the execution application 360, the criticality determination application 365, the heatmap generation application 370, the alert transmission application 375, and the mitigation application 380 may be a part of a single application. One or more processes performed by the network provisioning application 340, the parsing application 350, the token generation application 355, the execution application 360, the criticality determination application 365, the heatmap generation application 370, the alert transmission application 375, and the mitigation application 380 are described in detail below.

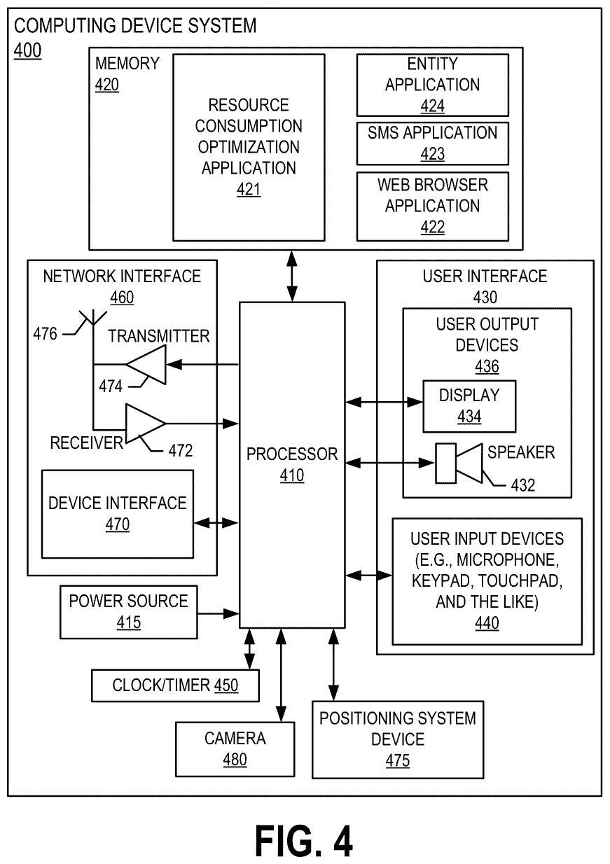

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource consumption optimization application 421, an entity application 424, or the like. These applications also typically instructions to a graphical user interface (GUI) on the display 430 that allows the user 110 to interact with the entity system 200, the resource consumption optimization system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

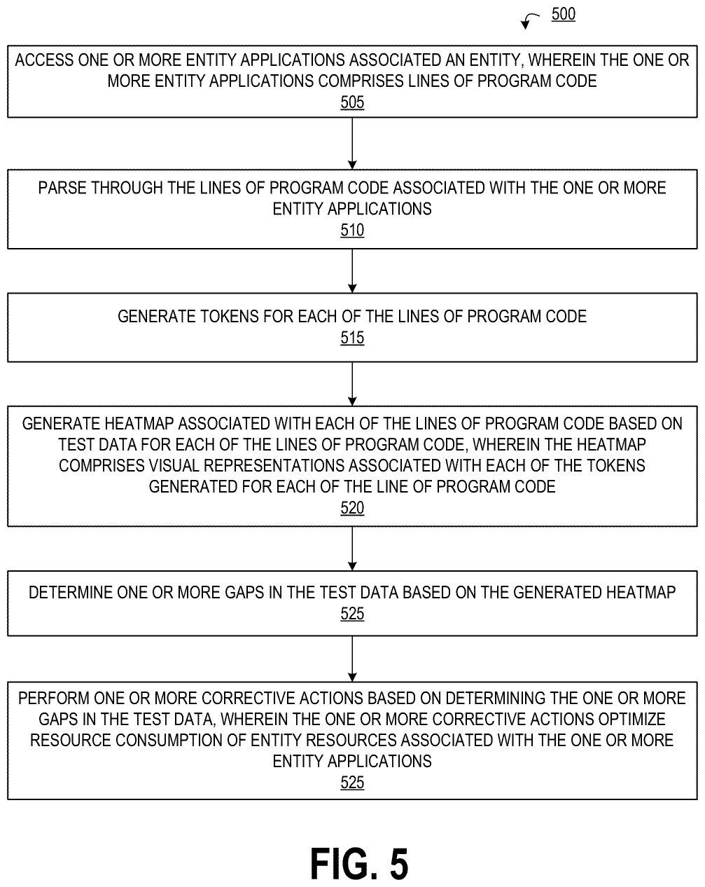

FIG. 5 provides a process flow for generating software code criticality and execution heatmaps to optimize resource consumption, in accordance with an embodiment of the invention. As shown in block 505, the system accesses one or more entity applications associated an entity, wherein the one or more entity applications comprises lines of program code. The one or more entity applications may be any applications that are being developed, maintained, utilized, managed, and/or the like by the entity. The one or more entity applications may be developed, tested and deployed into real-time environment by one or more users (e.g., application developers, application testers, software engineers, and/or the like via the computing device system 400). The one or more entity applications may comprise one or more modules, wherein each of the one or more modules may comprise one or more sub-modules, and each of the one or more sub-modules may comprise the lines of program code. In some embodiments, the one or more modules may not have one or more sub-modules and may have the lines of program code directly in the one or more modules.

As shown in block 510, the system parses through the lines of program code associated with the one or more entity applications. In some embodiments, the system may parse through each of the modules, the submodules, and the lines of the program code. The system analyzes the lines of program code and may identify different parameters, variables, values, functions, methods, and/or the like in each of the lines of program code. As shown in block 515, the system generates tokens for each of the lines of program code.

As shown in block 520, the system generates heatmap associated with each of the lines of program code based on test data for each of the lines of program code, wherein the heatmap comprises visual representations associated with each of the tokens generated for each of the lines of program code. In some embodiments, the system may receive the test data from the one or more users. In some embodiments, the system may extract the test data from a data repository. In some embodiments, the system may dynamically formulate the test data for testing the lines of program code. In some such embodiments, the system may generate the test data based on historical test data, real-time data, and/or the like associated with the one or more applications associated with the lines of program code. The system may generate the heatmap based on the test data for each of the lines of program code. The system may execute each of the modules, submodules, and the lines of the program code using the test data to identify criticality and execution frequency associated with modules, submodules, and the lines of program code. Based on the execution, the system may generate the heatmap comprising visual representations for each of the tokens in the lines of program codes, modules, submodules, and/or the like. The visual representations in the heatmap denote the criticality and the execution frequency associated with the tokens, lines of code, modules, submodules, and/or the like. In some embodiments, the system may use any kind of visual representations for displaying the heatmap and the criticality and execution frequency in the heatmap.

As shown in block 525, the system determines one or more gaps in the test data based on the generated heatmap. Based on the generated heatmap, the system may determine that a submodule of the ‘n’ submodules associated with a first module of the ‘m’ modules associated with an application is not executed at least once using the test data and may therefore determine a gap in the test data that resulted in non-execution of the submodule.

As shown in block 530, the system performs one or more corrective actions based on determining the one or more gaps in the test data, wherein the one or more corrective actions optimize resource consumption of entity resources associated with the one or more entity applications. The one or more corrective actions may comprise generating and transmitting alerts to one or more users associated with the one or more entity applications, modifying at least one of the lines of program code, commenting out the at least one of the lines of program code, rearranging the lines of program code, and/or the like.

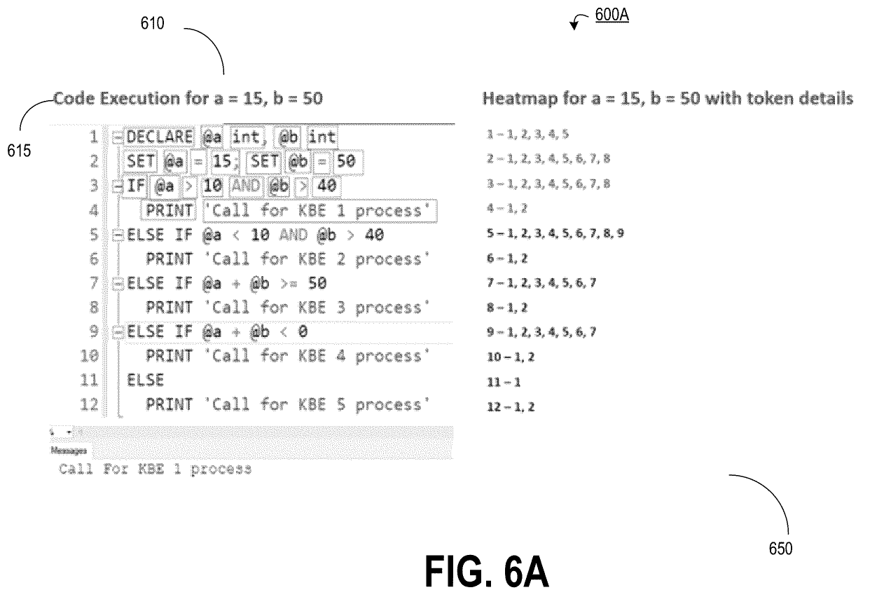

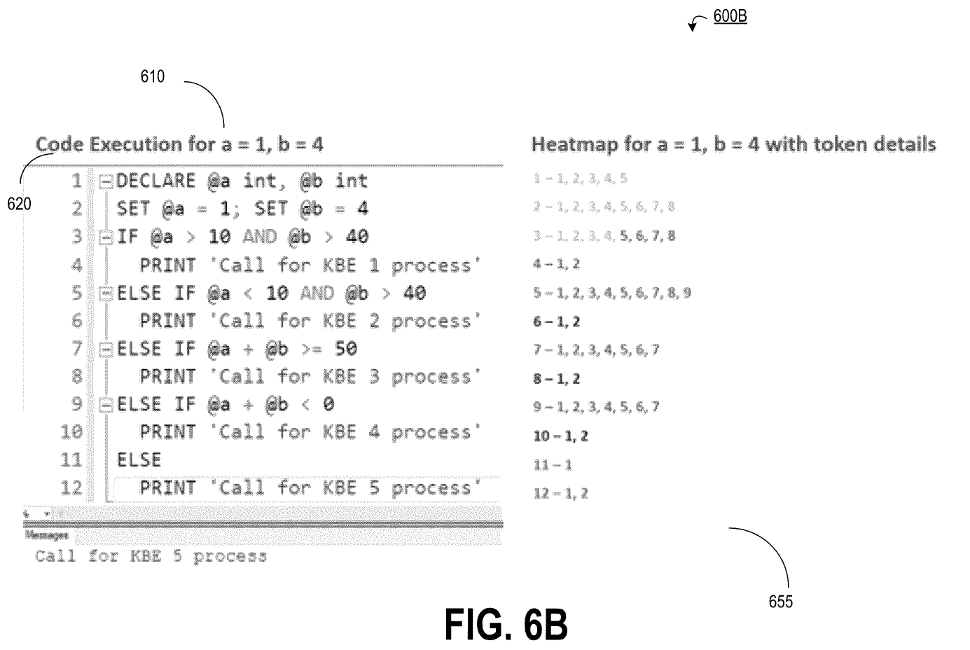

FIG. 6A and 6B illustrate examples for generating software code criticality and execution heatmaps with test data, in accordance with an embodiment of the invention. It should be understood that the examples described herein are for explanatory purposes only and the program code may be more complicated in real-time. As shown, program code 610 may be a part of a module and/or a submodule of an entity application, where the program code 610 comprises two sets of parameters that are defined based on test data or real-time data.

In FIG. 6A, the parameters are set as shown in label in 615, where ‘a’ is assigned a value of ‘15’ and ‘b’ is assigned a value of ‘50.’ As shown, a heatmap 650 is generated for the values corresponding to label 615, where the heatmap 650 comprises visual representations associated with tokens associated with the lines of program code 610. As shown, the system generates five tokens for first line in program code 610, eight tokens for second line in program code 610, and the like, where each of the tokens are represented via different visual representations (e.g., different color) based on the criticality and execution frequency of the tokens. As shown in heatmap 650, the first four lines of the program code 610 are executed once and are therefore displayed using a first visual representation element (e.g., first color) and the remaining lines of the program code 610 are not executed at least once using the test data in label 615 and are therefore displayed using a second visual representation element (e.g., second color).

In FIG. 6A, the parameters are set as shown in label in 620, where ‘a’ is assigned a value of ‘1’ and ‘b’ is assigned a value of ‘4.’ As shown, a heatmap 655 is generated for the values corresponding to label 620, where the heatmap 655 comprises visual representations associated with tokens associated with the lines of program code 610. As shown, lines 1-5, 7, 9,11, and 12 are executed when the values in label 620 are provided to the program code 610. As such, the lines that are executed are displayed using a first visual representation element (e.g., first color) and the remaining lines that are not executed are displayed using a second visual representation element (e.g., second color). In addition, each token in the line is visually represented using different visual representation elements (e.g., different colors, shading, or the like) based on the criticality and/or the execution frequency. For example, as shown in third line, the tokens 1-4 are displayed in a third color and tokens 5-8 are displayed in a fourth color.

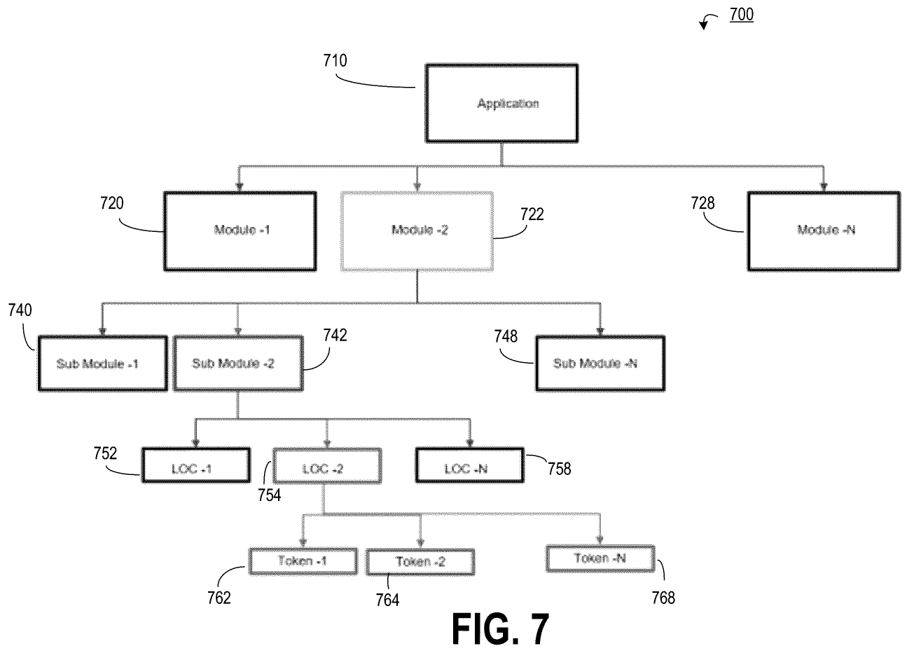

FIG. 7 illustrates a heatmap generated by the resource consumption optimization system 300, in accordance with an embodiment of the invention. As shown, the application 710 may comprise module ‘1’ 720, module ‘2’ 722, through module ‘N’ 728. Module ‘2’ 722 may comprise Submodule ‘1’ 740, Submodule ‘2’ 742 through Submodule ‘N’ 748. Submodule ‘2’ 742 may further comprise functions Log ‘1’ 752, Log ‘2’ 754, through Log ‘N’ 758. Function Log ‘2’ 754 may further comprise Token ‘1’ 762, Token ‘2’ 764, through Token ‘N’ 768. The value of ‘N’ in each of these different elements may vary and is not constant throughout the application 710. Upon execution, the system may determine that the Module ‘2’ 722 is a critical module based at least on execution frequency (e.g., may determine that it is executed ‘X’ number of times) and may display it via a first visual representation element (e.g., first color). Upon execution, the system may determine that the Submodule ‘2’ 742 is a critical submodule based at least on execution frequency (e.g., may determine that it sis executed ‘Y’ number of times) and may display it via a second visual representation element. The system may further determine that function Log ‘2’ 754 is executed at least once (e.g., ‘Z’ number of times, where ‘X’ and ‘Y’ may be greater than ‘Z’) compared to the other functions and may represent the function Log ‘2’ 754 using a third visual representation element (e.g., third color). In some embodiments, the first visual representation element, the second visual representation element, and the third visual element are different. In some embodiments, at least two of the first visual representation element, the second visual representation element, and the third visual element are the same.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

Claims:

1. A system for generating software code criticality and execution heatmaps to optimize resource consumption, comprising:
at least one processing device;
at least one memory device; and
a module stored in the at least one memory device comprising executable instructions that when executed by the at least one processing device, cause the at least one processing device to:
access one or more entity applications associated an entity, wherein the one or more entity applications comprises lines of program code;
parse through the lines of program code associated with the one or more entity applications;
generate tokens for each of the lines of program code;
generate heatmap associated with each of the lines of program code, wherein the heatmap comprises visual representations associated with each of the tokens generated for each of the line of program code; and
display the heatmap to one or more users.

2. The system according to claim 1, wherein the executable instructions cause the at least one processing device to generate the heatmap associated with each of the lines of program code based on executing the lines of program code based on test data.

3. The system according to claim 1, wherein the executable instructions cause the at least one processing device to:
determine one or more gaps in the test data based on the heatmap; and
perform one or more corrective actions based on determining the one or more gaps.

4. The system according to claim 3, wherein the one or more corrective actions comprise at least one of:
generating and transmitting alerts to one or more users associated with the one or more entity applications;
modifying at least one of the lines of program code;
commenting out the at least one of the lines of program code; and
rearranging the lines of program code.

5. The system according to claim 4, wherein the one or more corrective actions improve resource consumption of one or more entity systems executing the lines of program code associated with one or more entity applications.

6. The system according to claim 1, wherein the visual representations comprise representations that denote criticality and execution frequency associated with each of the lines of program code.

7. The system according to claim 1, wherein the one or more entity applications comprise modules, wherein each of the modules comprise submodules, and each of the submodules comprise the lines of program code.

8. A computer program product for generating software code criticality and execution heatmaps to optimize resource consumption, comprising a non-transitory computer-readable storage medium having computer-executable instructions for:
accessing one or more entity applications associated an entity, wherein the one or more entity applications comprises lines of program code;
parsing through the lines of program code associated with the one or more entity applications;
generating tokens for each of the lines of program code;
generating heatmap associated with each of the lines of program code, wherein the heatmap comprises visual representations associated with each of the tokens generated for each of the line of program code; and
displaying the heatmap to one or more users.

9. The computer program product according to claim 8, wherein the non-transitory computer-readable storage medium comprises computer-executable instructions for generating the heatmap associated with each of the lines of program code based on executing the lines of program code based on test data.

10. The computer program product according to claim 9, wherein the non-transitory computer-readable storage medium comprises computer-executable instructions for:
determining one or more gaps in the test data based on the heatmap; and
performing one or more corrective actions based on determining the one or more gaps.

11. The computer program product according to claim 10, wherein the one or more corrective actions comprise at least one of:
generating and transmitting alerts to one or more users associated with the one or more entity applications;
modifying at least one of the lines of program code;
commenting out the at least one of the lines of program code; and
rearranging the lines of program code.

12. The computer program product according to claim 11, wherein the one or more corrective actions improve resource consumption of one or more entity systems executing the lines of program code associated with one or more entity applications.

13. The computer program product according to claim 8, wherein the visual representations comprise representations that denote criticality and execution frequency associated with each of the lines of program code.

14. The computer program product according to claim 8, wherein the one or more entity applications comprise modules, wherein each of the modules comprise submodules, and each of the submodules comprise the lines of program code.

15. A computerized method for generating software code criticality and execution heatmaps to optimize resource consumption, the method comprising:
accessing one or more entity applications associated an entity, wherein the one or more entity applications comprises lines of program code;
parsing through the lines of program code associated with the one or more entity applications;
generating tokens for each of the lines of program code;
generating heatmap associated with each of the lines of program code, wherein the heatmap comprises visual representations associated with each of the tokens generated for each of the line of program code; and
displaying the heatmap to one or more users.

16. The computerized method according to claim 15, wherein the method comprises generating the heatmap associated with each of the lines of program code based on executing the lines of program code based on test data.

17. The computerized method according to claim 16, wherein the method further comprises:
determining one or more gaps in the test data based on the heatmap; and
performing one or more corrective actions based on determining the one or more gaps.

18. The computerized method according to claim 17, wherein the one or more corrective actions comprise at least one of:
generating and transmitting alerts to one or more users associated with the one or more entity applications;
modifying at least one of the lines of program code;
commenting out the at least one of the lines of program code; and
rearranging the lines of program code.

19. The computerized method according to claim 15, wherein the visual representations comprise representations that denote criticality and execution frequency associated with each of the lines of program code.

20. The computerized method according to claim 15, wherein the one or more entity applications comprise modules, wherein each of the modules comprise submodules, and each of the submodules comprise the lines of program code.
